(19) United States
(12) Patent Application Publication
(10) Pub. No.: US 2021/0174344 A1
(43) Pub. Date: Jun. 10, 2021

(54) SYSTEM AND METHOD FOR LOCATION BASED INDIVIDUALIZED MOBILE CONTENT AND MOBILE WALLET OFFERS

(71) Applicant: Digital Seat Media, Inc., Dover, DE (US)

(72) Inventors: Cameron Fowler, Fort Worth, TX (US); Matthew Sullivan, Austin, TX (US)

(21) Appl. No.: 16/812,203

(22) Filed: Mar. 6, 2020

Related U.S. Application Data
(60) Provisional application No. 62/814,292, filed on Mar. 6, 2019.

(51) Int. Cl. G06Q 20/36; G06K 7/14; G06K 7/10

(52) U.S. Cl. CPC G06Q 20/367; G06K 7/10712; G06K 7/1417

(57) ABSTRACT

A system for displaying customized mobile content to users at a venue via a user device, includes a server system in conjunction with a plurality of machine readable codes mounted within the venue. The server system performs the following steps: providing mobile content in a database; collecting user data associated with the user; receiving a request from one of the user devices, the request being generated by scanning one of the machine readable codes with the user device; determining the user data associated with the user who scanned the machine readable code; selecting, based upon the user data, customized mobile content from the mobile content in the database; and providing the customized mobile content to the user device.

### CROSS-REFERENCE TO RELATED APPLICATIONS

This application for a utility patent claims the benefit of U.S. Provisional Application No. 62/814,292, filed Mar. 6, 2019.

### BACKGROUND OF THE INVENTION

### Field of the Invention

This invention relates generally to systems and methods for providing location based individualized mobile content delivery. The system is capable of providing individualized content to each code, or a group of codes, based on a number of data points in real-time. The system also has the ability to alter provided multimedia content based on past data collected from user input and other factors in real-time. The system can be implemented in entertainment venues, as well as other areas where mobile engagement is desired and/or required, such as college dorm rooms, hotel rooms, cruise ships, trains, aircraft, rideshare vehicles and the like.

### Description of Related Art

Every machine readable code in a plurality of codes is typically programmed using an identical code (e.g., QR, Snap, etc.), NFC chip and/or machine readable code identifier/URL destination/App destination, etc. Using the same identifier on all codes does not typically allow for individualized content offerings on a “per code” basis.

The prior art teaches various systems and methods for providing content to persons attending an event at a venue, such as a sports event, concert, and other similar location-based events. Some level of customization is taught in some of these embodiments. Examples of these teachings include the following:

Marsico, W.O. 2015035055, teaches a system for performing multiple marketing operations at a sports venue, arena, etc. The system discusses a list of options, such as surveying a user, providing coupons, and other related provision of marketing materials. It also teaches enabling a user to order products (e.g., food) at the venue, for delivery to the scanned seat. The system uses a scannable information encoded graphic image, such as a bar code or a quick response (QR) code, near field communication (NFC) code, radio frequency identification (RFID) code. A mobile communication device such as a smartphone, tablet computer or other mobile computer may include a scan client module for scanning and communicating QR code information (either an app or without). QR code scanning is accomplished by a camera module that is associated with the smartphone or other mobile computing device. The scan-enabled client module communicates the scanned QR code information to an associated server application for collecting, processing and reporting scan data. Marisco, U.S. Pat. No. 9,223,885, teaches a similar system for gathering survey information via a QR code system.

Lim, U.S. Pat. No. 9,826,049, teaches the basic system wherein QR codes or the like are used in hardlink applications (linking a physical object or location with a web link), by which different users may receive different information in response to a user's interaction with a touchpoint. The content delivered to a particular user in response to a hardlink code or a presented hyperlink may be dependent on the time of the scan, the geographic location of the user, a weather condition at the geographical location, personal information associated with the user, a number of previous scans of the code by prior individuals, and any combination of the these or other variables, which may be determined by an originator of the QR code or other party. User devices may be re-directed to alternate content or network addresses based on one or more programmed conditions.

Beg, U.S. Pat. No. 9,451,389, teaches a system for communicating informational content using a near field communication (NFC). Uniquely programmed NFC stickers can be used conjunction with NFC enabled devices, such as a smart phone, to upload a personalized multimedia greeting on a central server. Once the stickers have been distributed, a recipient can tap on the same sticker and play the greeting message using the smart phone. Retail consumers can tap on NFC codes with a smart phone to view product informational content that has been hosted on the central server by retailers and manufactures.

Rodgers, U.S. Pat. No. 9,117,231, teaches an order taking system for ordering menu items for delivery to a station at a premises, such as a table at a restaurant. The system uses a downloaded application, which is used to scan a QR code or NFC code on a table. The location is identified using the restaurant and table identifier(s) extracted from the QR code. This location is used to identify the correct restaurant menu from the central platform database. The order may be placed, payment made, and delivery is made to the location corresponding to the QR code. Meter, U.S. 20160189287 teaches a similar food ordering system.

Horowitz, U.S. Pat. No. 9,002,727, teaches a system which uses a QR code (or NFC code) to direct a client device to send a first request to a first server identified by the URL. In response to the first request, the client device receives from the first server data configured to cause the client device to display, to a user of the client device, at least one of: a video or an interactive web page. Responsive to the data encoded in the QR code, the client device sends to a coupon server identification data associated with a user of the client device, and a request for the coupon server to distribute a digital coupon for an offer associated with an identifier encoded within the QR code to an account associated with the user. The distribution of the coupon may be predicated upon the user of the client device to perform a “predetermined activity” (e.g., watching an advertisement video, etc.) to qualify for the coupon.

Lewis, U.S. 2015/0081532, teaches a system that uses a combination of QR Codes and venue specific localized WI-FI to provide mobile venue related services in a covered venue area. The system includes food ordering and similar services, as well as a variety of other services.

### SUMMARY OF THE INVENTION

The present invention teaches certain benefits in construction and use which give rise to the objectives described below.

With regard to entertainment venues, the present invention provides a system for the display of interactive mobile content on a user device based on a number of determining factors including seat location, venue location, past user interactions, as well as data provided from other sources such as ticketing software and advertising database portals.

The system includes a plurality of machine readable codes or tags, each of the machine readable tags encoding an unique address and/or identification number that will direct the user device to a server system. The system may work independently of other multimedia displays located inside of the venue while providing content that is pre-scheduled or managed off site by the platform. The system may also orchestrate the displayed user content based on the display of the multimedia production on the venue multimedia display system, when it receives a request from one of the user devices, generated by scanning one of the unique machine readable and/or NFC enabled tags with the user device, and provides the interactive mobile content that corresponds, in real-time, with the multimedia production currently being played on the venue multimedia display system.

In one embodiment, the present invention provides a system for displaying customized mobile content to users at a venue via a user device. The system comprises a server system having a computer processor and a computer memory, the system further having a plurality of machine readable codes, each of the machine readable codes encoding an address controlled by the server system, and being operatively mounted within the venue for access by the users in the venue. The server system performs the following steps: providing mobile content in a database; collecting user data associated with the user; receiving a request from one of the user devices, the request being generated by scanning one of the machine readable codes with the user device; determining the user data associated with the user who scanned the machine readable code; selecting, based upon the user data, customized mobile content from the mobile content in the database; and providing the customized mobile content to the user device.

A primary objective of the present invention is to provide a system having advantages not taught by the prior art.

A further objective is to provide a system that enables a variety of interactions with the venue and the people attending an event at the venue, for increased entertainment, more effective sales at the venue, and more effective marketing. The objective of these interactions is to provide attendees individualized content that is based on multiple data points in order for content to be relevant to attendee on a personal level. Each scan of the uniquely encoded NFC enabled and/or machine readable tag will allow the system to provide personalized content to the user, while generating user data that can be attributed to a specific user who scanned that tag, or all past users who have scanned a tag specific to a venue or seat, utilized to provide more relevant content during current and future use sessions.

A further objective is to provide a system that collects a large amount of effective marketing information and analytics, which is of great value to companies marketing to this audience.

Another objective is to provide a system that provides greater level of customization to the content being disseminated.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawings illustrate the present invention. In such drawings:

FIG. 1 is a perspective view of a venue that includes machine readable codes which may be scanned to initiate delivery of customized content;

FIG. 2 is a block diagram of one embodiment of a system that enables delivery of the customized content, as illustrated in FIG. 1;

FIG. 3 is a flow diagram illustrating the operation of the system of FIG. 2;

FIG. 4 is a block diagram illustrating a second embodiment of the system; and

FIG. 5 is a flow diagram illustrating the operation of the system of FIG. 4.

### DETAILED DESCRIPTION OF THE INVENTION

The above-described drawing figures illustrate the invention, a method and system for location based individualized mobile content, wherein the system contains the ability to alter provided multimedia content based on data collected from user(s) input and other factors such as 3rd party data in real-time.

As discussed in greater detail below, a differentiator of the system is that it uses data input from several variables in order to provide real-time content to the end user. These data sets can be from a multitude of sources such as ticket brokers, which can provide details on a user who purchased tickets to an event, to advertising database data, which can provide past content interactions from various sources on and off the internet for a particular user. The system can also implement machine learning algorithms which, when coupled with a combination of some or all of the data provided from the analytics portal, can provide real-time content that is predicted to be favorable to the end user. The end user portal can be in various forms from browser based web pages, cloud based web apps, progressive web apps, downloadable apps, etc. These analytical datasets can also be used to provide in-venue content or offers to fans inside of an event based off of the collected data/feedback collected from users inside of the venue (i.e., if the analytics portal data reveals that 75% of users select hamburgers as their favorite type of food, the in-venue multimedia displays would be triggered to display content relevant to the selling of hamburgers). The system could provide multiple options ranging from ordering food, purchasing merchandise to be delivered to a seat location, viewing replay footage, to placing wagers inside of the stadium. The system would provide the ability to offer all tags in the system the same interactive content options, or to offer different content to users based on predetermined data sets.

In the event of a wagering component, users would be able to scan the NFC enabled and/or a machine readable code or tag located on their seat or other location (e.g., seat/bench/chair/wall/railing/glass in front of them) and be taken to a live wagering portal, which could be browser based or in the form of a cloud or locally based mobile application, including a progressive web app. Using the systems analytics server, the user would be able to see their past wagers across the entire system and place their wager utilizing a mobile wallet solution such as Apple Pay or Google Wallet, or through traditional payment methods.

All of the interactivity and wager based actions will be facilitated without the need for the user to create a traditional user profile. This same wagering configuration could be utilized to offer “brand wagers” wherein the prize given to the user is a physical item such as a promotional item from a team sponsor, or a digital reward which can be downloaded or emailed to the users mobile device.

Another interactive component that would provide value to the venues/teams/artists, etc., is the ability to donate money in real-time directly from their venue seat via the NFC and/or machine readable tags. If the donation was to the Salvation Army, the user would, either with or without prompting from the venue multimedia display system, scan their tag and be prompted to donate money either using their mobile wallet or traditional payment methods. In keeping with the earlier claims, the system would allow venue owners to deploy various donation templates to every seat, row, or section if desired. Additionally, after completing the donation, the user could be offered a physical or digital reward that could be used inside or outside of the venue.

The benefit of also utilizing user data that is gathered from outside of system itself is that it provides data that might not otherwise be gathered, while also offering an opportunity to “pre-set” content when a user scans the tag at their seat. Example 1—event ticket provider Ticketmaster provides data to the systems analytics portal that reveals that Joe purchased tickets to the football game to sit in seat 1 Row 1, while also providing data that Joe is a 32 year old male (data that is provided to Ticketmaster from Joe when he creates his account). Each tag in the system is uniquely encoded down to the individual seat, so the analytics portal would have the ability to “pre-schedule” content that would appeal to a 32 year old male when Joe takes his seat at the game. This use case could be very valuable for marketers looking to market to a particular subset of attendees vs. the entire stadium.

A machine learning component of the system would allow sports teams to provide more relevant real-time offers to fans by customizing content based on user interaction. Example 2—if Joe scans his Digital Seat tag and is taken to the team fan portal where he selects “buy merchandise” where he purchases a shirt 75% of the time, but he never buys a hat, then the system would have the ability to adjust Joe's offerings in real-time to show him a larger selection of shirts, instead of hats, based off of his past purchase and browsing habits. This could be extremely valuable to teams looking to sell items from merchandise to food inside of the venue. The system has the ability to learn user characteristics from user input within various user portals mentioned above (web browsers, PWAs, etc.). This component would provide a user with customized content based on their previous content interactions inside of one venue, or interactions across the entire system network of tags. It would also allow said system to store user and/or device information in order to offer specialized incentives based on past usage statistics (i.e., reward Joe for scanning the tag at his 10^{th} straight baseball game by giving him “team VIP” merchandise).

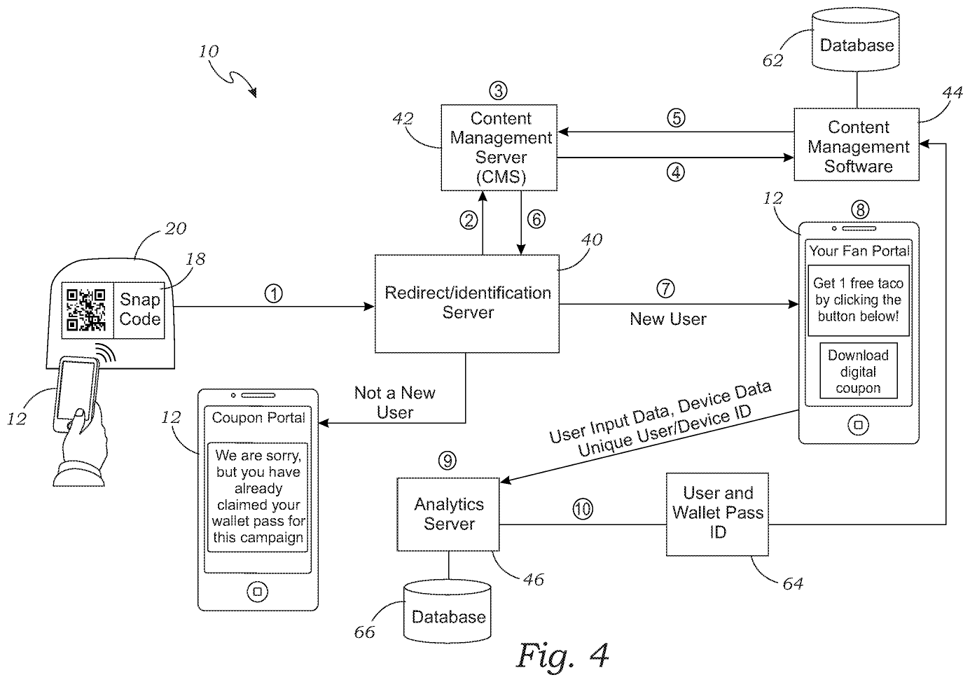

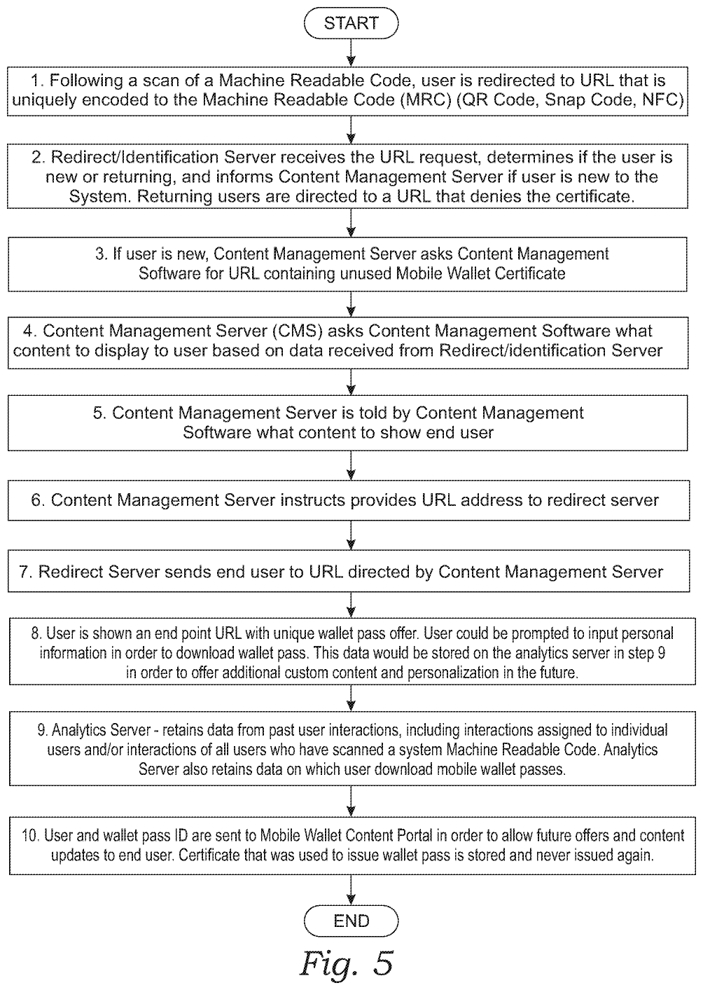

Another feature of the system is the ability to offer unique digital wallet passes, as shown in FIGS. 4-5, to each user who scans one of the system tags. This would allow venue owners, teams, universities, marketers, etc., to offer individualized wallet pass offers to every user that scans a system tag. Example 4—the system offers unique digital wallet passes for each user upon scanning the system tag, which means that if fifty users scan the same system tag with their mobile device, the fifty users are taken to a URL, cloud based application, or something of the like, and prompted to download a “digital wallet offer.” Every user who downloads said offer will have downloaded a digital wallet pass that is unique to their device, which also allows individual passes to be updated individually (updates include content, imagery, discounts, etc.). This is currently accomplished by providing a unique certificate for each mobile wallet pass. This process is facilitated by the redirect/identification server making a determination on if a user and/or device that has entered the system is unique, and if the answer is “yes,” the content management server will request content from the content management system which includes an unissued, unique mobile wallet pass that is only offered one time to one user. The system would also contain the ability to offer “group passes” wherein the system could offer a digital wallet pass that was only able to be issued to a pre-determined number of users. The system could also be implemented within a traditional mobile application or web based platform whereas the user would be offered the unique digital mobile wallet offer once they visit said application or web address.

The machine learning and custom content aspect of the system is not limited to in-venue applications and can be utilized across multiple industries such as rideshare vehicles, aircraft, ships, trains, hotel rooms, dorm rooms, vacation rentals, etc. The broad spectrum of the invention is to offer location based custom content solutions to users' mobile devices.

In the case of hotels and collegiate dorm rooms, the system would be comprised of a plurality of uniquely encoded tags placed inside of guest rooms whereas there is one NFC enabled and/or machine readable tag per room, or one tag per guest/resident of said room. Each tag would be connected to system servers which would allow said tags to offer pre-determined content based on pre-supplied data points. In the collegiate dorm case, users would scan the tag located within their room and be shown content based on various factors such as their gender, education major, year of schooling, etc. The content on these tags would also utilize data points and usage reports from the system itself to better serve users with relevant content. These tags could also allow marketers, and the university at which they are deployed, to offer incentives such as game tickets or retail store coupons, directly to the students in their dorms, while providing the option to provide the offers and content to only select, or all, tags based on various analytics provided within the system. Tags would also allow students and hotel guests to offer real time feedback on the system in the form of user submissions to conduct live polling procedures. This use case would provide a valuable platform for universities, marketers, and hotel owners to offer customized content to their guests on an individualized basis.

Another unique feature of the system is that the data that is collected in order to provide content can be gathered system wide when a user scans one of the plurality of tags in any location. This feature would allow marketers to understand consumers characteristics more closely from a location experience, and to provide the user relevant content across a multitude of markets. Example 5—if a system tag is scanned by Joe at a football game in Arlington on a Sunday, and then a system tag is scanned by Joe in a rideshare vehicle in Boston the following Wednesday, the system would understand that the user, Joe, was the same for both interactions and display content accordingly based on data provided from the analytics portal.

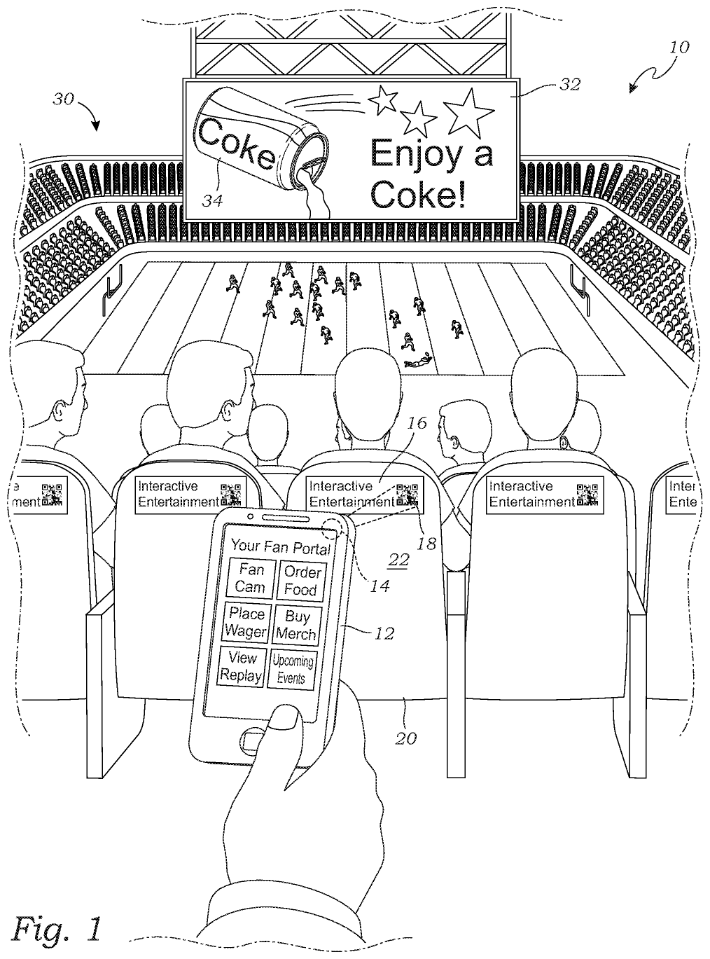

FIG. 1 is a perspective view of one embodiment of a venue 30 that includes machine readable codes 18 positioned within the venue 30 to be scanned with a user device 12 to initiate delivery of customized content to the user device 12, as discussed in greater detail below. The venue 30 may be any form of stadium, arena, field, competition area, performance hall, etc., for which this system 10 might be suitable. The system 10 can be implemented in entertainment venues, as well as other areas where mobile engagement is desired and/or required, such as college dorm rooms, hotel rooms, cruise ships, trains, aircraft, rideshare vehicles and the like. While some examples of the uses of this system are discussed herein, the scope of the present invention should not be limited to the specific examples provided, and the term “venue” should be construed to include alternative or equivalent embodiments which could be devised by one skilled in the art.

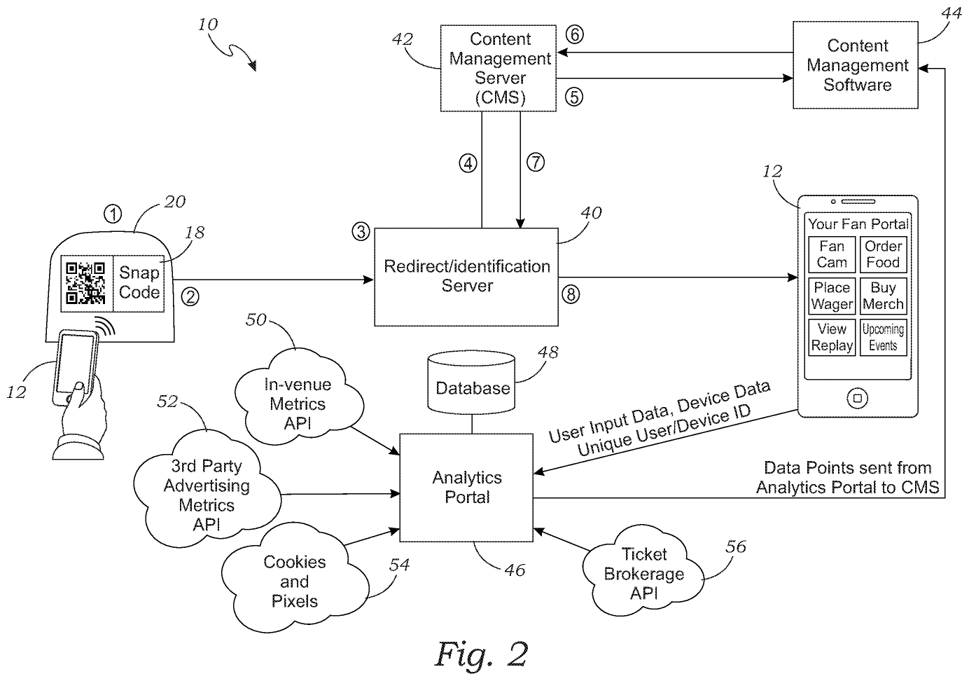

In this embodiment, a user device 12 (e.g., mobile electronic device, such as a smart phone) may be used to scan or otherwise detect one of the machine readable codes 18 to enable a system (one embodiment of which is shown in FIG. 2) to provide interactive mobile content to the user device 12. This may be performed by placing the user device 12 adjacent an NFC chip, or by using a camera 14 of the user device 12 to capture an image of the machine readable code 18, so that the QR code (or other form of code) is captured. The user device 12 is then directed to content, as discussed in greater detail below.

As shown in FIG. 1, in this embodiment, the plurality of machine readable codes 18 are each part of a tag 16 positioned adjacent one of a plurality of seats 20 in the venue 30, in this case on a back surface 22 of the seat 20 in front of the user (or a wall, etc., if no seat is in front). The machine readable codes 18 could alternatively be placed in other locations (e.g., the ground, ceiling, walls, pillars, other surrounding structures). While one example of this placement is illustrated, this should be broadly construed to include any placement in the venue that is suitable for use as described herein. Alternative placement schemes that may be devised by one skilled in the art, consistent with the teachings of the present invention, should be considered within the scope of the present invention.

Each of the machine readable codes 18 encodes an address that will direct the user device 12 to a redirect/identification server 40 (shown in FIG. 2), as discussed in greater detail below.

For purposes of this application, the term “machine readable codes” should be broadly construed to include any form of bar code, quick response (QR) code, near field communication (NFC) code, radio frequency identification (RFID) code, or any other equivalent device or technology known in the art, or later developed. It may be in the form of a separate piece of material (e.g., metal, plastic, etc.) that is installed in the venue, or it may be printed or otherwise provided within the venue (e.g., printed on or integrally formed with one of the seats, or other surfaces or structures of the venue).

The machine readable codes 18 are adapted to be read by a user device 12, typically a mobile “smart” phone, although alternatively any form of laptop computer, tablet computer, personal digital assistant (PDA), netbook computer, and the like. The machine readable codes 18 can be programmed to automate tasks, such as, for example, to change phone settings, create and send a text, launch an application, or any number of commands to be executed, limited only by the communication device.

The system 10 (shown in FIG. 2), as discussed in greater detail below, may be programmed to allow, for example, advertisers, team owners, promoters, performers, and the like to direct the individuals to a specific webpage, or have the user device 12 perform a specific action when the machine readable codes 18 are scanned by the user device 12 (i.e., by a camera 14 of the user device 12). While some other particular examples are discussed below, it should be understood that countless alternative systems may be implemented using this system 10, and such alternatives should be considered within the scope of the present invention.

In other embodiments, the machine readable codes 18 may allow individuals to perform contactless transactions such as, for example, purchase tickets, order meals, and shop for merchandise directly from their seat while inside the event facility. In a typical embodiment, the plurality of machine readable codes 18 are encrypted with data that can be updated remotely on a real time basis via, for example, a URL redirect page, or by sending and launching an application (“app”). In addition, in a typical embodiment, the plurality of machine readable codes 18 are linked together and viewed as a network rather than individual machine readable codes 18.

In the embodiment of FIG. 1, the machine readable codes 18 may be provided on rigid plates or stickers, and/or containing NFC chips or other similar chips, and are programmed to perform individually designated actions. For example, NFC codes can be programmed to automate tasks such as, for example, allowing for a change of phone settings, a text to be created and sent, turning on device via Bluetooth, and the like. While this may be effective in some cases, such individually designated actions are not optimal for event facilities where a different message may need to be delivered at various times throughout an event. In a typical embodiment, the exemplary system and method allows the plurality of machine readable codes 18 to be programmed to perform various designated actions, allowing operators of the event facilities to cater personalized messages to specific sections or individual seats within the event facility rather than one designated action for the entire event facility.

For example, if the event facility is a sports stadium, as shown in FIG. 1, the plurality of machine readable codes 18 can be prompted to swipe or scan the user device 12 on the seat in front of them, via NFC, QR code, etc., to receive content. In other embodiments, upon swiping or scanning the user devices 12, the individuals may be directed to a different advertiser's webpage at certain times in the game so that multiple different advertisers can utilize the plurality of machine readable codes 18 during the game. In other embodiments, the plurality of machine readable codes 18 may also have the ability to download a digital coupon onto the communication devices which could be redeem at a concession area or retail location. The machine readable codes 18 also have the ability to be synced to live media that will run on digital screens within the venue 30 via scheduling software, as discussed in greater detail below.

Another use for the invention would be for retailers to offer real time discounts to users in specific venues via the machine readable codes 18. For example, if the machine readable codes 18 inside of the venue 30 are linked to a specific retailer, then that retailer could offer discounts in real time that could only be accessed by users inside of the venue 30.

Mobile payment is a rapidly expanding business segment and NFC applications such as, for example, contactless transactions are expected to be the most widely adopted form of mobile payments. Embodiments of the invention provide individuals an ability to establish radio communication between their communication devices and the plurality of machine readable codes 18 by touching them together or bringing them into close proximity, via NFC, usually no more than a few centimeters. Embodiments of the invention also provide individuals an ability to establish interactive communication via machine readable codes. In a typical embodiment, the plurality of interactive codes can be programmed to perform various designated actions such as, for example, an ability to download a digital coupon straight onto the communication devices which could be redeemed at a concession area or retail location. For example, the digital coupon could be redeemed by the individuals upon performing a transaction at a retail or concession area using, for example, the NFC enabled communication device. This provides concession owners, retail owners, and advertisers an ability to immediately see conversion rate of a coupon that is issued (i.e., 100 coupons were scanned via the plurality of machine readable codes and 80 were redeemed). These digital coupons could be redeemed at retail locations inside or outside of the event facility.

In a typical embodiment, each interactive code of the plurality of interactive codes has a unique identification number that is stored within a database allowing a specific message to be delivered to each of the plurality of machine readable codes 18 within the event facility at a given time. This provides individuals an ability to order meals and have their meals delivered to their seats by scanning their communication devices against the plurality of interactive codes and being directed to a webpage. This is especially useful providing the fact that this can be accomplished via a standard mobile web browser vs requiring the user to download an application onto their mobile device.

Along with remotely updating the plurality of machine readable codes 18 by utilizing URL redirecting technology, the exemplary method and system is configured to collect and aggregate analytical data every time an individual scans the plurality of interactive codes. When the plurality of machine readable codes 18 are scanned with the communication devices, analytical data is collected. The analytical data may be, for example, date, time, GPS location of an machine-readable code, type of communication device used to scan an machine-readable code, orientation of a communication device when a machine-readable code was scanned, and type of operating system on a communication device that scanned an interactive code. The exemplary method and system couples the collected analytical data from the physical scanning of the plurality, of machine readable codes 18 with data collected once the individual is directed to the webpage. In a typical embodiment, the data may be, for example, time spent on a webpage, purchases made, IP address, personal information input by the user, and products viewed. Such data is of high value to, for example, advertisers, team owners, and venue owners as it provides a large insight into consumers purchasing and web browsing habits. This embodiment could also be used to allow for real time data/polling of event attendees, e.g., voting for your favorite player, etc.

In a typical embodiment, remotely updatable machine-readable code programming provides an ability for individuals to download digital coupons directly to their communication devices and transfer the digital coupon to other communication devices. In a typical embodiment, once the individual transfers the digital coupon to a predefined number of communication devices, the incentivized offer increases. For example, upon brining their communication device in close proximity to an machine-readable code, the individual may be directed to a webpage from where the individual downloads a digital coupon for 10% off at a local retail store. If the individual transfers the digital coupon from his/her communication device to, for example, five other communication devices within a fixed time period such as, for example, a week, the coupon offer automatically upgrades from 10% to 20% off at the local retail store. This capability offers further incentive for individuals to transfer their digital coupons to family and friends so that they will receive greater discounts. Also, this capability will allow brands and retailers to watch their promotion go viral from a first point of download to various locations where the coupons are transferred between various communication devices. These coupons/promotions could also be shared and tracked via NFC, MMS, SMS, social media such as Facebook, Twitter, Snapchat, etc. Mobile coupons could be browser based or stored into users digital wallet located on their mobile device.

In other embodiments, the remotely updatable machine readable codes 18 may be included into identification badges such as, for example, student identification badges, employment identification badges, concert badges, and the like. For example, the inclusion of the machine readable codes 18 in the student identification badges provides an ability to students to scan their identification badges and be automatically redirected to a webpage that would show what is being served for lunch, sports schedule, and the like. The webpage may also include advertising that may be changed on a daily basis. Additionally, according to some embodiments, the machine readable codes 18 may be included into, for example, magnets that parents could place in their house, cars, and the like. The magnets with machine readable codes 18 could be scanned with communication devices to access information such as, for example, grades, school information, and the like. For example, the inclusion of the machine readable codes 18 within concert credential codes would allow fans to scan the codes in order to get exclusive content, offers, etc. In other embodiments, a code, attached or not attached, to a lanyard, would be handed out to every attendee of a concert. While at said concert, the fan could scan their machine-readable code for a chance to win back-stage passes, merchandise, etc. Any data input from said fan would also be collected in real time. These machine readable codes 18 could also be placed on merchandise, such as but not limited to, shirts, hats, CDs, sweatshirts, pants, posters, etc.

Furthermore, various embodiments are described more fully hereinafter with reference to the accompanying drawings, which form a part hereof, and which show, by way of illustration, specific exemplary embodiments by which the innovations may be practiced. The embodiments may, however, be embodied in many different forms and should not be construed as limited to the embodiments set forth herein; rather, these embodiments are provided so that this disclosure will be thorough and complete, and will fully convey the scope of the embodiments to those skilled in the art. Among other things, the various embodiments may be methods, systems, media, devices, or any similar or equivalent arrangements known to those skilled in the art. Accordingly, the various embodiments may take the form of an entirely hardware embodiment, an entirely software embodiment or an embodiment combining software and hardware aspects. This detailed description is, therefore, not to be taken in a limiting sense.

In addition to the data discussed above, it is also possible for the system, as discussed below, to gather a large amount of data about the user, from various sources, to further enable customization of the content provided. This is discussed in more detail below.

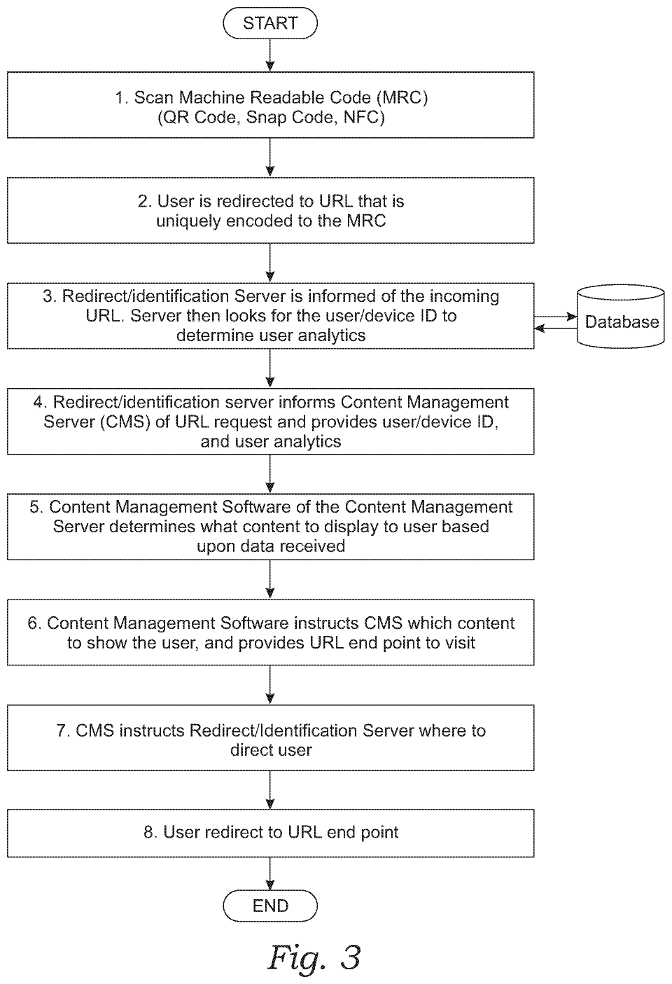

FIG. 2 is a block diagram of one embodiment of a system 10 that enables delivery of the customized content, as illustrated in FIG. 1. FIG. 3 is a flow diagram illustrating the operation of the system 10 of FIG. 2. As shown in FIGS. 2-3, in this embodiment the system 10 includes a redirect/identification server 40 that is operably connected to a network (e.g., internet, or other form of network known in the art). For purposes of this application, the term “server” (or any other similar term, such as “computer,” “computer device,” “electronic device,” “user device,” “portal,” etc.), refers to any form of electronic device or plurality of devices having at least one computer processor, e.g., a central processing unit (CPU), and some form of computer memory having a capability to store data, as is well known in the art. The server may comprise hardware, software, and firmware for receiving, storing, and/or processing data as described below. The hardware may be in a single unit, or operably connected via a network. For example, a computer or server may comprise any of a wide range of digital electronic devices, including, but not limited to, a server, a desktop computer, a laptop, a smart phone, a tablet, or any form of electronic device capable of functioning as described herein. Furthermore, while multiple devices may be described (e.g., a content management server 42, an analytics server 46, and others), these may all be performed on a single computer device, or multiple associated computer devices, according to the teachings of one skilled in the art.

The term “computer memory” as used herein refers to any tangible, non-transitory storage that participates providing instructions to a processor for execution. Such a medium may take many forms, including but not limited to, non-volatile media, volatile media, and any equivalent media known in the art. Non-volatile media includes, for example, ROM, magnetic media, and optical storage media. Volatile media includes, for example, DRAM, which typically selves as main memory. Common forms of computer memory include, for example, hard drives and other forms of magnetic media, optical media such as CD-ROM disks, as well as various forms of RAM, ROM, PROM, EPROM, FLASH-EPROM, solid state media, such as memory cards, and any other form of memory chip or cartridge, or any other medium from which a computer can read. While several examples are provided above, these examples are not meant to be limiting, but illustrative of several common examples, and any similar or equivalent devices or systems may be used that are known to those skilled in the art.

Furthermore, the term “database” as used herein, refers to any form of one or more (or combination of) relational databases, object-oriented databases, hierarchical databases, network databases, non-relational (e.g. NoSQL) databases, document store databases, in-memory databases, programs, tables, files, lists, or any form of programming structure or structures that function to store data as described herein.

The computer memory of the redirect/identification server 40 stores executable code that, when executed, enables the computer system to perform a process that comprises multiple steps, such as the process shown in FIG. 3. As described in FIG. 3, the process is initiated when the user device 12 is used to scan (or otherwise detect or read) the machine readable code 18 in the venue 30 (as shown in FIG. 1), such as placing the user device 12 adjacent the NFC chip, or using the camera 14 (shown in FIG. 1) of the user device 12 to capture an image of the machine readable code 18, so that the QR code (or other form of code) is captured.

The user device 12 then sends a request to the redirect/identification server 40, to a unique URL encoded in the code. When the redirect/identification server 40 receives the inquiry, the redirect/identification server 40 is able to determine a user/device ID that identifies either the user, the device used, or both. This information is captured and may be used in many ways to determine further information about the user who is scanning the code 18. This information is used later, as discussed below, to customize the content being delivered to the user device 12.

The redirect/identification server 40 delivers this information to the content management server 42 (“CMS”). Content management software 44, operably installed on the CMS 42, the uses the user data to determine what content to deliver to the user device 12, based upon the user data received. The content management software 44 may draw data about the user from multiple potential sources, which may be collected, for example, by an analytics portal 46, and which may be stored in a database 48. In one embodiment, the step of receiving a user ID/device ID from the user device provides significant data about the user. For example, the user ID may enable the direct collection of data about the user, from multiple sources. The device ID may be connected with the user, via records from the service provider, and therefore enable collection of data about the user.

The step of collecting user data associated with the user may also include the step of receiving in-venue metrics via an in-venue metrics API 50. This API 50 may enable information about the user to be gathered based upon purchases of tickets (past and present), purchases of food, merchandise, and other goods and services from the venue.

The step of collecting user data associated with the user may also include the step of receiving third-party metrics via a third-party metrics API 52. This API 52 may enable information about the user to be gathered from third-parties who participate in a shared program, or who sell or otherwise provide marketing information, demographics, and other data about the user.

The step of collecting user data associated with the user may also include the step of receiving information from tools 54 such as cookies, pixels, and similar tools. These tools 54 enable information about the user based upon activities of the user on the current system 10, as well as related screen time, such as browsing the internet, using other sites and software, etc.

The step of collecting user data associated with the user may also include the step of receiving information from ticket brokerage metrics via a ticket brokerage metrics API 56. These metrics may include information gathered by the ticket brokers who sell tickets at the venue 30, and may include a wide range of marketing data, not only about ticket purchases made, but also related information about the user.

In this embodiment, the content management software 44 determines content instructions, based upon the user data that is gathered, and relays those content instructions to the Content Management Server 42, the Content Management Server 42 then instructions the Redirect Server 40 of which URL should be displayed to the user, Redirect Server 40 then directs the user device 12 to the final end point (application, URL, etc.). The user device 12 then arrives at the end point, and displays the mobile content to the user. For purposes of this application, the term “real-time” means any interactions that are provided within 10 seconds of an event occurring.

The step of providing the interactive mobile content may also include the steps of selecting and/or generating the desired content, suitable for the particular user, in a format for use in a mobile application, and transmitting the mobile application and the desired content to the user computer 12. In one embodiment, the system 10 utilizes a cloud based application. For the cloud based app to work, an application (or “app”) is written (in a suitable format for IOS, Android, etc.), then either loaded onto a cloud based platform, or ported into a cloud based OS. Once in the cloud platform, the app can be accessed from a mobile device and displayed as if it were running natively on the user device.

FIG. 4 is a block diagram illustrating a second embodiment of the system 60, and FIG. 5 is a flow diagram illustrating the operation of the system 60 of FIG. 4. As shown in FIGS. 4-5, the system 60 includes many of the same components discussed above, including the redirect/identification server 40, the content management server 42, and the analytics server 46. The function of these components in this embodiment, however, includes alternative steps, as discussed in greater detail below.

In this embodiment, following a scan of the machine readable code 18 with the user device 12, as discussed above, the user is redirected to a URL that is uniquely encoded to the machine readable code 18. The redirect/identification server 40 receives the URL request, determines if the user or new or returning, and informs the content management server 42 if the user is new to the system 60. Returning users who are determined to not be new are directed to a URL that denies the certificate. In this embodiment, it is the redirect server 40 that makes the determination as to whether the user is new or returning; however, in an alternative embodiment, all user inquiries could be forwarded to the content management server 42, and the determination as to whether they are new or returning could be made there.

In this embodiment, the content management server 42 includes a database 62 of URL's containing unique certificates used to issue mobile wallet passes. The wallet passes may be limited to a single use by each user. If the user is determined to be a returning user, not a new visitor, this user may be denied access to the mobile wallet pass, to ensure that a user does not access multiple rewards. If the user is new, the content management server 42 determines, via the content management software 44, a URL containing an unused mobile wallet certificate, taken from the database 62. The content management software 44 determines what content to display based upon data received from the redirect/identification server 40, and the content management software 44 provides a URL address to the redirect/identification server 40, which provides the URL address to the user, so that the user device 12 is directed to the selected end point. The content provided includes a unique wallet pass offer.

As part of this process, the user could be prompted to input personal information in exchange for the wallet pass. The provided information could be stored in a database 66 of the analytics server 46. The analytics server 46 retains data from past user interactions, including interactions assigned to individual user and/or interactions of all users who have scanned code 18. The analytics server 46 also retains data on which user downloaded the mobile wallet passes.

The user and wallet pass ID's are sent to the mobile wallet content portal to allow future offers and content updates to the user. The certificate that was used to issue the wallet pass is stored and never used again.

While two embodiments of this invention are disclosed in this specification, it is to be clearly understood that the invention is not limited to these embodiments, but rather the scope of the invention is defined by claims made to the invention. As used in this application, the words “a,” “an,” and “one” are defined to include one or more of the referenced item unless specifically stated otherwise. The terms “approximately” and “about” are defined to mean +/−10%, unless otherwise stated. Also, the terms “have,” “include,” “contain,” and similar terms are defined to mean “comprising” unless specifically stated otherwise. Furthermore, the terminology used in the specification provided above is hereby defined to include similar and/or equivalent terms, and/or alternative embodiments that would be considered obvious to one skilled in the art given the teachings of the present patent application.

What is claimed is:

1. A method for delivering mobile content to a user device, through the use of a machine readable code, comprising the steps of:
upon scanning the machine readable code with the user device, determining an identification of either the user, the user device, or both;
determining information about the user based upon the identification of either the user, the user device, or both;
customizing the mobile content to the user; and
delivering the customized mobile content to the user device.

2. A system comprising a computer system that has the capability to offer unique digital mobile wallet pass items to every user device which interacts with said computer system via a machine readable code.

3. A system for displaying customized mobile content to users at a venue via a user device, the system comprising:
a server system having a computer processor and a computer memory;
a plurality of machine readable codes, each of the machine readable codes encoding an address controlled by the server system, each of the machine readable codes being operatively mounted within the venue for access by the users in the venue; and
wherein the computer memory of the server system stores executable code that, when executed, enables the server system to perform a process that comprises the following steps:
providing mobile content in a database;
collecting user data associated with the user;
receiving a request from one of the user devices, the request being generated by scanning one of the machine readable codes with the user device;
determining the user data associated with the user who scanned the machine readable code;
selecting, based upon the user data, customized mobile content from the mobile content in the database; and
providing the customized mobile content to the user device.

4. The system of claim 3, wherein the step of collecting user data associated with the user comprises the step of receiving a user ID/device ID from the user device.

5. The system of claim 3, wherein the step of collecting user data associated with the user comprises the step of receiving in-venue metrics via an in-venue metrics API.

6. The system of claim 3, wherein the step of collecting user data associated with the user comprises the step of receiving third-party metrics via a third-party metrics API.

7. The system of claim 3, wherein the step of collecting user data associated with the user comprises the step of receiving ticket brokerage metrics via a ticket brokerage metrics API.

8. The system of claim 3, wherein the step of collecting user data associated with the user comprises the step collecting data via cookies or pixels.

9. The system of claim 3, wherein the machine readable codes each include a QR code, a snapcode, a near field communication (NFC) code, or a radio frequency identification (RFID) code.

10. The system of claim 3, wherein the system that has the capability to allow in-venue donations to be given from a mobile device via scanning the machine readable code.
